(19) United States
(12) Patent Application Publication
(10) Pub. No.: US 2016/0119389 A1
(43) Pub. Date: Apr. 28, 2016

(54) SYSTEM AND METHOD FOR MANAGING INTERRUPTIONS BY INDICATING AN AVAILABILITY STATUS ON A COMMUNICATION DEVICE

(71) Applicant: CANFOCUS TECHNOLOGIES INC., Toronto (CA)

(72) Inventors: LAHAV MOSHE GIL, Toronto (CA); IGAL ROYTBLAT, Richmond Hill (CA)

(21) Appl. No.: 14/895,781

(22) PCT Filed: Jun. 4, 2014
(86) PCT No.: PCT/CA2014/000481

§ 371 Date: Dec. 3, 2015

Related U.S. Application Data
(60) Provisional application No. 61/830,966, filed on Jun. 4, 2013.

(51) Int. Cl. H04L 29/06; G06Q 10/10; H04L 29/08; G06F 3/0484; H04L 12/58

(52) U.S. Cl. CPC H04L 65/403; G06F 3/04842; H04L 51/24; H04L 67/26; G06Q 10/107

(57) ABSTRACT

A computer system and computer implemented method for managing interruptions by indicating an availability status on a first communication device. The method is performed by said first communication device and a computer server, the method comprising: (a) receiving an input from a user, the input comprising a request to interrupt or resume communications or notifications processed by other communication devices or communication platforms; (b) sending commands to the other communication devices or communication platforms based on the request to interrupt or resume; and (c) starting or terminating in real time or near real time, based on the request to interrupt or resume communications or notifications, respectively, a Do-Not-Disturb (DND) state, wherein the DND state comprises that the user for a period of time is not interrupted by communications or notifications from the other communication devices or communication platforms. Accordingly, the computer system provides a multi-platform interrupt functionality that can be initiated by a single input to a device so as to “shut off multiple communication devices or communication platforms, thereby allowing the user to focus on tasks without being disturbed.

### FIELD OF THE INVENTION

The present invention relates generally to time management. The present invention further relates to methods and systems for managing incoming communications in order to manage time better.

### BACKGROUND OF THE INVENTION

Modern workplaces benefit from the convenience of numerous communication tools such as VoIP phones, mobile devices, email systems, Internet chat systems, SKYPE™, Google+Hangouts™, video-conferencing tools, collaboration platforms, social LANs such as IGLOO™ Also, workers often subscribe to various online platforms that may generate alerts or notifications such as for example content platforms or news feeds, social media platforms and so on.

The messages or notifications that can be generated by such tools and platforms can be overwhelming and distracting, causing at times multiple unpredictably or unfortunately timed interruptions.

Also, people at their work place are often disturbed by managers and peers, which interrupts employees' concentration, reducing their efficiency and productivity. Declining an interruption by a colleague or manager may be perceived as rude behavior, hence workers will typically allow such interruptions. Alternatively, a worker may keep a door to an office closed to avoid such interruptions, but that unfortunately also discourages necessary or productive discourse.

Typically, meeting rooms and lecture halls are considered places where interruptions are not acceptable, and people tend to avoid disturbance in such places. Even when a person works in an office/cubical, people sometimes are considerate, passing by without interruption. When the individual, however, is part of a computer network and/or connected to other communication means, his/her colleague has no way to determine if the person is busy or free for communication.

While at their desk, workers may or may not be available for interacting with others depending on the current task they are performing. Avoiding interruptions at inopportune times may greatly enhance work productivity. Thus, there is a need for new approaches to achieving such.

It is generally understood that to complete certain tasks productively, there is a need to restrict distractions by other co-workers but also by communication tools or platforms, at least for a period of time.

Similar considerations apply in individuals' personal lives, whereby for example distractions represented by different network connected devices may interfere with a particular activity or set of activities that the person wishes to engage in.

There is need for systems and methods that build on the concepts of the Prior patent but more importantly, address integration with various communication tools and platforms, and other requirements.

There is a need for systems and methods that meet some of these requirements.

### SUMMARY OF THE INVENTION

In accordance with an aspect of the present invention there is provided a method, performed by a communication device and a computer server (or server), the communication device associated with a user and in communication with the computer server over a communication network, comprising: (A) receiving input from a user or a computer system consisting of a request to interrupt communications or notifications processed by one or more communication devices or communication platforms; (B) a server computer initiating interruption commands to the one or more communication devices or communication platforms to define simultaneously, or almost simultaneously, a do-not-disturb mode where the one or more users for a period of time are not interrupted by the communication devices or communication platforms, until a period of time expires, or based on further input to terminate the do-not-disturb period is received.

In accordance with another aspect, one or more rules are defined for a work place, for providing periods of time where one or more users work without interruption, and others when the one or more users may be interrupted, and these rules are used to define settings associated with the server computer.

In another aspect of the present invention, an apparatus is provided that connects to the time management system and is used by the user to provide the input to the server computer for initiating interruption of the communications or notifications, and optionally to indicate visually to co-workers the do-not-disturb mode.

In accordance with another aspect of the present invention there is provided a computer-implemented method for time management, the method being performed by a communication device and a server connected to a communication network, the method may comprise:
(A) receiving an input from a user or a computer system associated with the user, the input comprising a request to interrupt or resume communications or notifications processed by one or more communication devices or communication platforms connected to the server;
(B) sending commands, by a processor of the server, to the one or more communication devices or communication platforms based on the request to interrupt or resume; and
(C) starting or terminating in real time or near real time, based on the request to interrupt or resume communications or notifications, respectively, a Do-Not-Disturb (DND) state, wherein the DND state comprises that all communications or notifications from the one or more communication devices or communication platforms be silenced or paused.

In another aspect of the present invention, the method may further comprise receiving an input from the user or the computer system associated to the user to indicate a neutral state, wherein the neutral state comprises that some communications or notifications from the one or more communication devices or communication platforms be silenced or paused.

In another aspect of the present invention, the method may further comprise receiving an input from the user or the computer system associated to the user to indicate a free-to-collaborate (FTC) state, wherein the FTC state comprises that none of communications or notifications from the one or more communication devices or communication platforms be silenced or paused.

In yet another aspect of the present invention, the method may further comprise prior to the step of receiving input from a user or a computer system associated to the user, the step of pairing the communication device to the user or the computer system associated to the user, wherein the communication device is a standalone clicker device.

In accordance with one aspect of the invention, pairing the communication device to the user or the computer system associated to the user may comprise the steps of:
(a) sending, by the communication device, an unique hardware identifier associated with the communication device to a pairing server;
(b) based on the unique hardware identifier, sending, by the pairing server, a user ID that was last assigned to the communication device before it was turned off or went offline.

In accordance with another aspect of the invention, pairing the communication device to the user or the computer system associated to the user may comprise the steps of:
(a) sending, by the communication device, an unique hardware identifier associated with the communication device to a pairing server;
(b) receiving a pairing request by the pairing server, the pairing request comprising at least a user ID associated with the user;
(c) prompting the user to click and hold the communication device;
(d) receiving signals indicating that the user has clicked and is holding the communication device;
(e) prompting the user to release the communication device;
(f) receiving signals indicating the user has released the communication device; and
(g) pairing the communication device with the user by assigning an unique hardware identifier associated with the communication device to the user ID.

In accordance with yet another aspect of the invention, the method may further comprise:
(a) determining a context;
(b) determining a set of rules based on the context, wherein the set of rules indicate one or more states associated with the user and with the communication device;
(c) starting, in real time or near real time, the one or more states based on the determined context, wherein the one or mare states require none, some or all communications or notifications from the one or more communication devices or communication platforms be silenced or paused.

In accordance with one aspect of the invention, the context can be determined based on at least one of: day of week, time of day, location of the user, calendar information, default setting, user-defined setting, and group setting.

In accordance with another aspect of the invention, if the determined context is a personal context, then the determined set of rules may indicate a work-DND state, which comprises that all work related communications or notifications from the one or more communication devices or communication platforms be silenced or paused.

In accordance with another aspect of the invention, if the determined context is a work context, then the determined set of rules may indicate a personal-DND state, which comprises that all non-work related communications or notifications from the one or more communication devices or communication platforms be silenced or paused.

A communication device for time management is provided, the device may comprise a first unit comprising a visual indicator configured to display a current user state associated with a user, the first unit connected to a server over a communication network, wherein: (1) the first unit is configured to: (a) receive an input from the user, the input comprising a request to interrupt or resume communications or notifications processed by one or more communication devices or communication platforms connected to the server; and (b) send the request to the server; and (2) the server comprises a processor and a non-transitory computer-readable memory, the processor upon executing instructions stored in the non-transitory computer-readable memory is configured to: (a) upon receiving the request to interrupt or resume, send commands to the one or more communication devices or communication platforms based on the request to interrupt or resume; and (b) start or terminate in real time or near real time, based on the request to interrupt or resume communications or notifications, respectively, a Do-Not-Disturb (DND) state, wherein the DND state comprises that all communications or notifications from the one or more communication devices or communication platforms be silenced or paused.

In accordance with another aspect of the invention, the system may comprise a second unit mountable on a wall, the second unit comprising a visual indicator that is configured to be synchronized with the visual indicator of the first unit so that both the first and the second units can display the current user state associated with the user in real time or near real time.

In accordance with another aspect of the invention, the first unit and the second unit may be wirelessly connected.

In accordance with another aspect of the invention, there may be further provided a base unit that is configured to receive and charge the first unit or second unit, wherein the base unit is further configured to connect the first unit or second unit to the computer network.

In one aspect of the invention, the first unit and the second unit may be interchangeable.

In another aspect of the invention, the processor of the server may be configured to: receive a request from the first unit, the request indicating a neutral state, wherein the neutral state comprises that some communications or notifications from the one or more communication devices or communication platforms be silenced or paused.

In another aspect of the invention, the processor of the server may be configured to: receive a request from the first unit, the request indicating a free-to-collarborate (FTC) state, wherein the FTC state comprises that none of communications or notifications from the one or more communication devices or communication platforms be silenced or paused.

In yet another aspect of the invention, the processor of the server may be configured to: (a) determine a context; (b) determine a set of rules based on the context, wherein the set of rules indicate one or more states associated with the user and with the communication device; and (c) start, in real time or near real time, the one or more states based on the determined context, wherein the one or more states comprise none, some or all communications or notifications from the one or more communication devices or communication platforms be silenced or paused.

In one aspect of the invention, the context can be determined based on at least one of: day of week, time of day, location of the user, calendar information, default setting, user-defined setting, and group setting.

In another aspect of the invention, if the determined context is a personal context, then the determined set of rules may indicate a work-DND state, which comprises that all work related communications or notifications from the one or more communication devices or communication platforms be silenced or paused.

In yet another aspect of the invention, if the determined context is a work context, then the determined set of rules may indicate a personal-DND state, which comprises that all non-work related communications or notifications from the one or more communication devices or communication platforms be silenced or paused.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates an exemplary flow chart of operation of a system in accordance with a possible implementation of the invention.

FIG. 2 is a diagram illustrating one aspect of the cross-platform architecture of the present invention.

FIG. 3 is a program resource diagram illustrating resources of the client application.

FIG. 4 illustrates the VoIP integration of the present invention.

FIGS. 5a and 5b illustrate the integration of the computer system with analog phones.

FIGS. 6a and 6b illustrate different aspects of the computer system including a clicker device.

FIG. 7 illustrates an exemplary representative generic implementation of the invention.

### DETAILED DESCRIPTION

Features of the systems, devices, and methods described herein may be used in various combinations, and may also be used for the system and non-transitory computer-readable storage medium in various combinations.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may transform electronic signals of various data objects into three dimensional representations for display on a tangible screen configured for three dimensional displays. One should appreciate that the systems and methods described herein involve interconnected networks of hardware devices configured to receive data using receivers, transmit data using transmitters, and transform electronic data signals for various three dimensional enhancements using particularly configured processors, where the three dimensional enhancements are for subsequent display on three dimensional adapted display screens.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It is to be understood that a user in this disclosure may mean, without limitation, an employee, a manager, a group of users, a group of meeting attendees, or any other suitable target user group.

The term “clicker” may mean, without limitation, a physical clicker device, an associated wall unit of the clicker device, or a computer system that is associated with or serves as a clicker device.

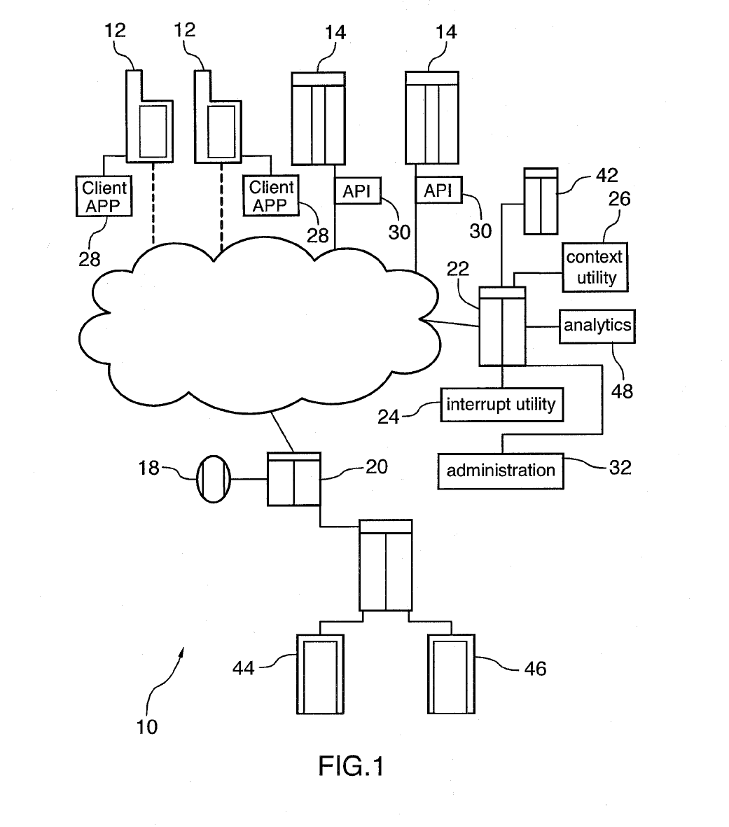

FIG. 1 shows an exemplary embodiment of the computer system of the present invention.

A time management computer system and computer implemented method is provided (“solution”). The computer system (10) can receive as input, information regarding one or more communication devices (12) of at least one user (the “user”), and optionally also one or more communication platforms (14) associated with the user, wherein the communication devices (12) or communication platforms (14) may generate communications or notifications to the user which may be distracting, may break the concentration of the user, or may otherwise impede the user's ability to complete tasks productively that benefit from uninterrupted activity or concentration over a period of time. These tasks may be work-related or non-work related or personal in nature.

In one aspect, the computer system (10) includes at least one communication device (18) that receives input that triggers the computer system (10) to initiate suspension of communications and/or notifications, across some or all of the associated communication devices (12) or communication platforms (14) of the user, in real time or near real time. The communication device (18) also receives input that triggers the computer system (10) to re-initiate communications and/or notifications, across all of the communication devices (12) or communication platforms (14), in real time or near real time. The computer system (10) provides a multi-platform interrupt functionality that can be initiated by a single input to a device so as to “shut off” multiple communication devices (12) or communication platform (14) features that otherwise would distract the user. Significantly, multiple devices may be associated with the computer system (10); the multiple devices may be associated with a user, a manager or a group of users that may be affected by the interruption), and any authorized device, in addition to the communication device (18), can initiate or terminate the “do-not-disturb” (sometimes referred to as “DND”) mode across multiple devices and platforms, in an efficient manner.

In one aspect, the communication device (18) may be a clicker device that can receive user input from a click motion by the user and can communicate information regarding a user defined “state” associated with a user or group of users. The communicated information regarding the user defined state can serve or reflect a set of guidelines or rules for others to engage (or not engage) with the user or group of users. These may be based on preferences and/or policies for reducing or limiting interruptions.

The states may be defined or modified by users, managers, system administrators or by the computer system in accordance with a default set of instructions.

Various states are possible such as a “do not disturb” state, a “don't interrupt” state or equivalent, and an “engage” state, free-to-collaborate state, or equivalent state. Do-not-disturb (“DND”) or “don't interrupt” state may indicate that the user or group of users do not wish to be disturbed; while free-to-collaborate (“FTC”) state may indicate that the user or group of users is available for collaboration or discussion. A third state may be possible such as a “neutral” state. This may be used in part to avoid the “engage” or “free-to-collaborate” state being perceived as an invitation to disturb or interrupt, which may increase disruptions beyond what is necessary or appropriate. The various states may be associated with one or more signals, which may be visual, audible or communicated in some other medium. A neutral state may be used to indicate that the user may be open to discussion or interruption when necessary, as he or she is currently not engaged in a task that is associated with the do not disturb (DND) state, while avoiding the appearance of an open invitation to chat or talk, so that others know to only disturb the user when there is a valid reason and need.

In some embodiments, a default state for the communication device 18 can be a neutral state.

In another possible aspect of invention, in addition to the concept of state, there may be a further concept of “context”, which may be associated with state, but the relationships between context and any given state may depend on the particular context. In one possible implementation, context may be used to determine automatically one or more rules related to one or more states; and this may depend on additional information such as day of week, time of the day, location of the user and so on.

For example, an individual may have a “work” context and a “personal” context. During a specific period of time, such as on a weekend, a default context setting for the user or group of users may be the personal context, which may automatically cause the computer system 10 to determine that the user is in a work-DND or a neutral state that indicates the user or group of users is available to friends and family but not for work related disruptions. In another example, a change of context to the work context may have the opposite effect. The change may happen automatically as the weekend changes into a work week (e.g. SAM on Monday), or it may happen during certain hours of the day (e.g. 2-4 PM on a Sunday). The change of context and associated states may be pre-determined, set by default, obtained from the user, or modified by the users. Concurrently or alternatively, the context may be determined based on calendar information of the user that is accessible on any one of the user's communication devices or communication platforms that are connected to the server computer. Furthermore, if it is determined that the user is currently in the office (e.g. based on GPS data associated with the user's mobile device), even if it's on a weekend, the server computer 22 or the context utility 26 may determine that the user is at work and therefore a DND state should be turned on for at least an hour before being switched to a neutral state.

In another aspect of the invention, based on corporate policy or individual preference, the context of “personal” and “work” can be defined as time of day. For example, one may be in work context from 9 AM to 5 PM otherwise they will be in personal context. Another may be in work context from 6 AM to 8 PM and otherwise in personal context.

Furthermore, it is possible to use the context, for example, in the following way:

When in a work context, the system can timeout the DND state after 1 hour of continuous DM state (i.e. system will automatically switch the user from red to green after 1 hour on red). When in a personal context, the system will have reverse timeout logic (i.e. switch user from green to red after 1 hour on green). This way, the system encourages the users to collaborate during work hours with up to 1 hour bursts of focus while it will encourage and remind people to go home and not to be distracted with work related issues during off-work hours.

Being in a particular context does not need to affect all connected devices. That is, devices can be excluded from a given context. For example, a personal smartphone that has the MyFocus client application installed should not be muted when in a personal context even if the system times out of green (free-to-collaborate) and switches to red (DND state).

Each user can have a user profile that stores a set of rules associated with each context, the set of rules can further indicate one or more states, timeout duration and settings, and other parameters associated with determining when and how communications or notifications are interrupted for the user.

In one aspect, the communication device (18) may include a visual indicator, and means for receiving input from a user, for example using a clicker device (18) that can be manually activated or deactivated by the user, so as to switch the clicker (18) from an “ON” or “DON'T INTERRUPT” position (indicating a corresponding state) to an “OFF” or “READY TO COMMUNICATE” position (indicating a corresponding state), and vice versa. As stated earlier, a third “NEUTRAL” position or state is also possible.

In one possible implementation, “OFF” may be associated with a GREEN colour, “ON” may be associated with a RED colour, and WHITE or YELLOW or BLUE may indicate a neutral state.

In one aspect the clicker device 18 may be linked to a computer device (20) such as a desktop computer, a tablet computer, a laptop computer or a smart phone. In another aspect of the invention, the clicker device, or simply a clicker (18) may also be implemented as a standalone device that is not directly connected (via wired or wireless access) to a computer device 20. The standalone clicker device 18 may be a computer device or another kind of device, operable to receive input from the user. In the case of the standalone clicker device 18 being implemented as a standalone computer device, the standalone computer device may include hardware, software, and middleware resources of a computer, a tablet, or a mini-computer.

A standalone clicker device 18 may also be a simple device that is directly connected to a network, instead of being directly connected to a computing device. Such standalone clicker devices may be often utilized in hoteling spaces where desks or offices are not assigned to a specific user for a prolonged period of time. Therefore, in order for a user who is temporarily (e.g. for a day or a week) assigned to the hoteling space to use the clicker device 18, he or she needs first to pair the clicker device to a computer system assigned to or logged in by the user. The pairing process is described in detail below in this disclosure.

In either case, the activation/deactivation of the clicker results in a message being sent to a server computer (22), in one implementation, as shown in FIG. 1. The input for activating/deactivating of clicker device 18 or associated user states sent to the server computer (22) may be generated in a number of ways, such as a swipe of a user interface for the client application (28) on a mobile device; or it may be generated automatically after a set DND time has expired; when an employee has reached their quote of cumulative DND periods for a day, and so on. Various different rules for triggering activation/deactivation of the interrupt functions can be implemented.

The server computer (22) includes an interrupt utility (24) that in real time or near real time sends messages to the communication devices (12) or communication platforms (14) that are acted on by the communication devices (12) or communication platforms (14) (through one or more APIs), to interrupt some or all communications or notifications that may be distracting to the user.

In one aspect of the invention, the input for activating (or starting)/deactivating (or terminating) a clicker, a state or a context via a clicker device 18 may consist of the user manually clicking the clicker (18). In another aspect, the clicker (18) includes a visual indicator for indicating whether the computer system is in an “OFF” mode or an “ON” mode. The visual indicator may also indicate a particular state the user is in (e.g. DND state). The visual indicator may be designed to be visible by other personnel to indicate whether the user should or should not be disturbed.

In another possible aspect of the invention, the computer system (10) may include a context identifying component implemented as a context utility (26). The context identifying component may for example use a variety of attributes such as time of day, day of week, calendar information or location information (which may be generated, obtained from devices or applications, or otherwise determined) so as to establish a current or future context of the user or group of users.

For example, the content identifying component may analyze network connections to determine the location of the user, or a probable location. The context identifying component may include or embody one or more rules that establish degree of certainty that a user is in one context or another, and when a threshold of certainty is not met, the context identifying component may attempt to obtain additional information, and re-compute the degree of certainty and determine if the threshold has been met. Alternatively, the context identifying component may, depending on the rules, solicit feedback from the user, and use the resulting information to re-compute the degree of certainty.

The context identifying component may also use GPS data to determine location, or approximate location.

In one aspect of the invention, the communication device (18) can be a mechanism for reminding others, and also possibly oneself, that one has made a commitment to complete a certain task and to be focused on that task, and not on other applications or devices. When this level of commitment is not present, even when completing a task, a user can be distracted because they are expecting for example an email or call to arrive (which often it does). Even this expectation of something else can be distracting, or at least may decrease productivity, as compared to focused attention on a task or set of tasks.

In one aspect therefore, the computer system (10) addresses substantially all sources of workplace distractions—those from employees in the workplace (through the physical clicker (18) and associated workplace rules for respecting its state or status) and the various communication devices (12) and communication platforms (14) which the computer system (10) integrates with in an effective manner, as described below.

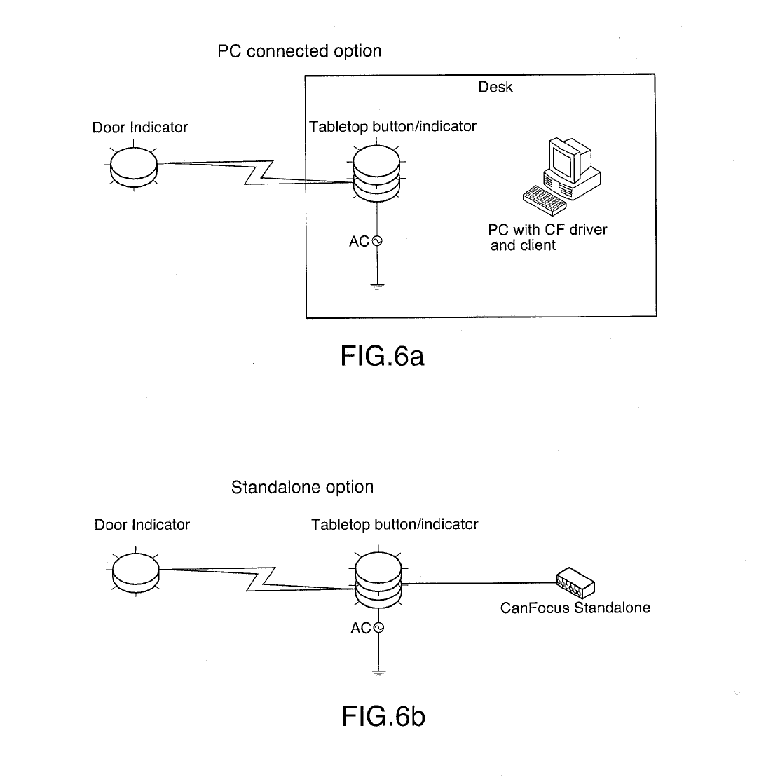

As shown in FIGS. 6a and 6b, the clicker (18) may include a first unit (e.g. tabletop button/indicator) that may be placed in a work area so that it is readily accessible to the user, and a second unit that may be placed so as to be visible in an office doorway (for example, a door indicator unit on a wall outside an office door), where the first unit and the second unit each includes a visual indicator that are synchronized to display the same state or status. The user may for example switch the first unit at his/her desk to show that the user is in a “DON'T INTERRUPT” state or status, which results in an associated visual indicator being displayed both on the first unit and the second unit. The first unit and the second unit may be connected to one another by means of a wireless connection.

In a further aspect, the first unit and the second unit each can include a battery; the first unit is received by a base or cradle for charging the first unit and also connecting the first unit to a computer network for communication with the server computer (22). In another aspect, the first unit and the second unit are interchangeable, where each can function both as a clicker and a wall indicator, wherein each unit when received by the base functions as the clicker, and each unit when placed on a wall mounted base functions as a visual indicator that displays a visual indicator of a status that is automatically synchronized with the status of the clicker. The first unit and the second unit may be configured to automatically search for one another wirelessly and establish a wireless connection therebetween. Whichever unit of the clicker is mounted on the wall is connected only wirelessly to the other unit; the other unity will generally connect to the cradle and the cradle generally connected to a fixed Internet connection associated for example with a desktop computer in the user's office.

The present invention may be implemented along with associated workplace policies or training to promote personnel respecting the status of the computer system, including use of the “DON'T INTERRUPT” setting of the computer system.

In another aspect, the input consists of a computer system generated event. For example, a calendar system permits the definition of one or more “do not disturb” periods associated for example with the user's scheduled work on a project. The time of day and schedule “do not disturb” period may automatically trigger the system to switch to a “DON'T INTERRUPT” status.

As shown in FIG. 1, the interrupt utility (24) may consist of a server computer component and also a client application (28) that is implemented on each communication device (12). the client application (28) can be configured to integrate with communication device functions so that in response to an associated message from the server computer (22) (such as an interrupt message, i.e. a message encoded specifically to initiate one or more interruption related operations), the interrupt utility (24) can cause activation or deactivation of one or more states across the various communication devices (12), simultaneously or substantially simultaneously.

In another aspect, the interrupt utility (24) includes one or more APIs (30) for interoperating with one or more communication platforms (14) for interrupting one or more distracting functions of the communication platforms (14), such as for example alerts or notifications generated by the communication platforms (14).

In another aspect, the server computer (22) provides a central hub that is maintained to include up to date programming for interrupting communications or notifications. The programming is updated to address changes required to effectively interrupt communications or notifications because of changes in communication device or communication platform features or functions. The central service provided by the server computer (22) reduces the workload involved in creating and maintaining an exhaustive list of APIs and processes required to integrate with all the difference communication devices and platforms that may cause distractions, across diverse workforces, in different countries. The operator of the server computer (22) invest the resources in adding new communication platforms and mechanisms that enable the automation of interruption features, and also streamlining of setup of such communication platforms for a user or group of users on the computer system (10).

In another aspect, the present invention includes unique and innovative features for (A) muting a smart phone; (B) diverting calls to a VoIP line to a voice mailbox; (C) muting an analog phone system or a; and (D) changing the routing scheme of a private branch exchange or PBX put a particular extension in do-not-disturb mode.

Without the present invention, it would be time consuming to shut off so many communication devices or communication platform features. Without the present invention, with the multitude of communication devices and communication platforms used by the average user, the user would be unlikely to shut off all relevant communication devices and communication platforms, and therefore would be less productive. Communication device and communication platform features and functions vary with time, but the computer system can be updated to address these variations.

### Cross-Platform Architecture

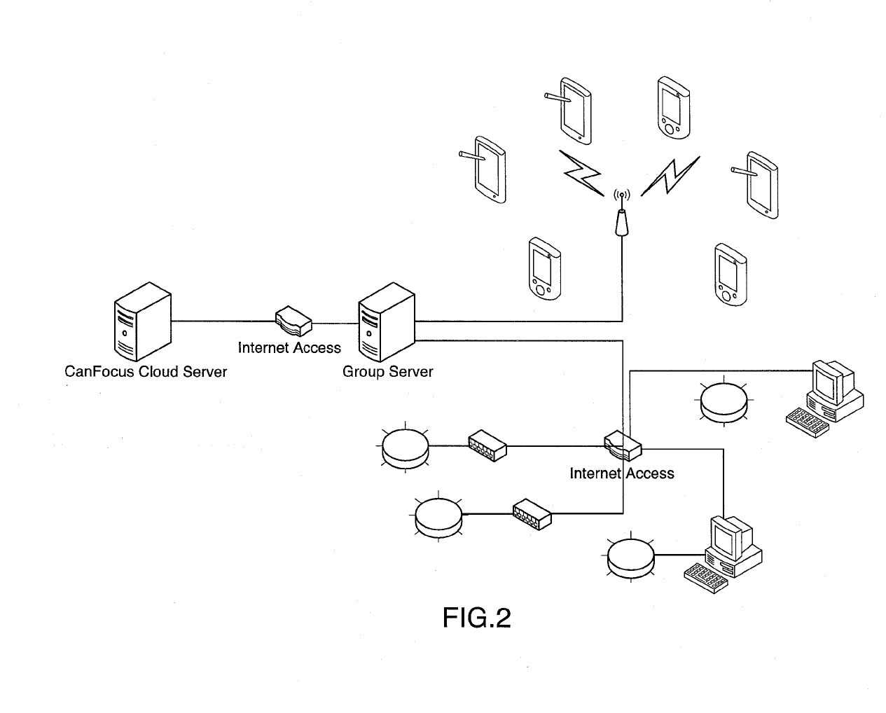

As best illustrated in FIG. 1, and also as shown in FIG. 2, the computer system includes a cross-platform computer architecture that includes a cloud-based server computer that acts as an access point for all associated communication devices (12). As shown in FIG. 2, in one example implementation of the present invention the computer system can be shown as having a star topography in which the server computer (22) is situated at a centre point. In the case of groups of users, the topography would take on a more tree like structure.

The server computer (22), as shown in FIG. 1, may include an administration utility (32) which organizes the various accounts associated with individual users, the groups that they are associated for user group management functions and so on.

For example, administration utility (32) can reflect that User A and User B are both part of Group C, such that if Group C is working on a project, requiring that both User A and User B to be DND for a certain period of time, server computer (22) can automatically initiate interrupt commands or functions in relation to User A and User B, along with other members of Group C if any, across all of their communication devices (12) and communication platform (14), simultaneously or near simultaneously.

The interrupt utility (24) may implement a series of rules for synchronizing status across one or more devices (12) or communication platforms (14) relevant to each user, and across multiple users and their devices (12) or communication platforms (14). The interrupt utility (24) also includes features for managing different time zones, as personnel of enterprise clients are spread across geography, and also are mobile.

As previously described, the computer system (10) applies interrupt functionality across various relevant devices (12) or communication platform (14) simultaneously, or near simultaneously. In one aspect, the server computer (22) uses a suitable communication protocol for synchronizing status across multiple devices (12) and platforms (14) for this purpose, where the status is either “ON” or “OFF” as previously described.

In another aspect of the invention, multiple devices are connected to another through the computer system (10). Optionally, a user switches the computer system (10) to a DND status using the clicker device, or this may be done for example using a feature of the client application (28) as implemented for example to a smart phone. Providing input to a first associated device, automatically results in the switching off of not just the first associated device, but any second associated devices, including those associated for example by participation in the same group activity that requires DND state or status.

### Client Application

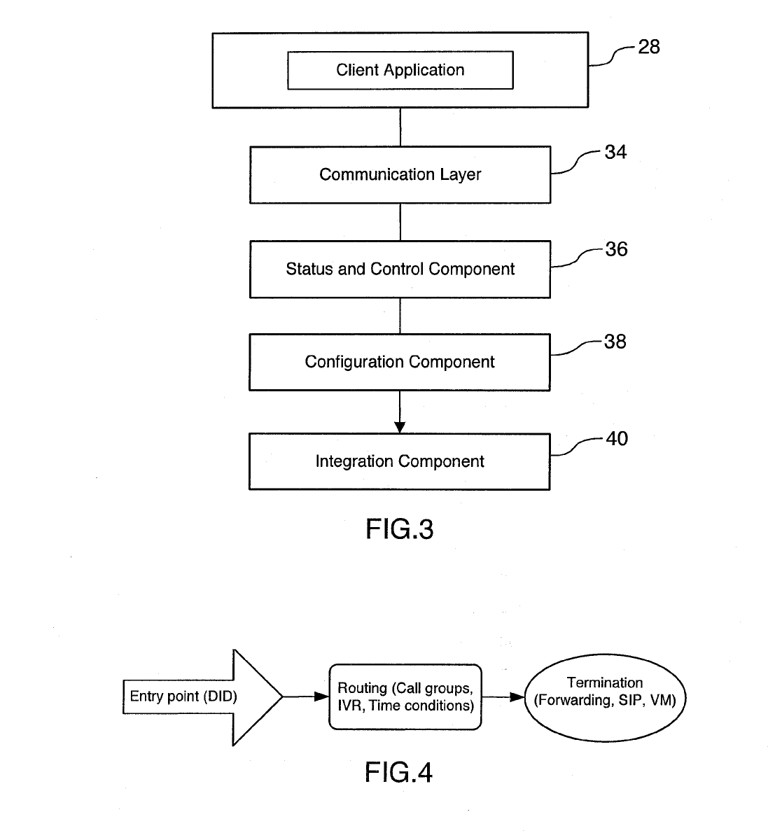

The client application (28) is designed to be configurable to operate on a wide variety of communication devices. In one aspect, different versions of the client application (28) may exist for different operating systems, however, different versions generally have the same or similar key components. FIG. 3 includes a program resource diagram illustrating the functions of the present invention embodied in the client application (28).

As further explained below, the client application (28) shares common or similar components, whether implemented to a desktop computer or smart phone, but generally speaking in one example implementation there is a first version of the client application (28) for desktop computers, laptop computers, and tablet computers (that may be connected to the enterprise network in a fixed or wireless manner), and a second version for smart phones, which are generally part of the enterprise network but generally are less integrated with the network and therefore do not receive network updates etc.

In one aspect, the client application (28) is: (A) loaded on a network-connected device, whether a mobile device, a tablet computer or a desktop computer, (B) checks a list of applications from a library created by the client application (28) that consists of a list of devices or platforms that are likely to be distracting to the user, (C) determines whether such applications or links to such platforms exist on the network-connected device. The client application (28) may then load a set of set-up routines or screens that guide the user through a series of workflows related to setting up the user on the computer system. Examples of such set-up routines or screens are referenced below.

As shown in FIG. 3, the client application (28) generally includes: (A) a communication layer (34) that manages authentication and communication with the server computer (22), (B) a status and control component (36) that reads and displays the status of the associated network-connected device, (C) a configuration component (38) that associates the user with his/her clicker, so that depressing an input means or button on the clicker generates a message associated with the user so as to interrupt associate devices (12) or platforms (14) only for the user, and (D) an integration component (40) that contains the subcomponents or routines required to support activation of ON/OFF status for various devices or platforms (further details are provided below).

The ON/OFF status may be power on/off, simply a silence/normal mode of operation, or temporary pausing or resuming of communication or notification messages on a device or platform.

In another aspect, the configuration component (38), in one implementation, presents one or more screens that obtains passwords. For example, in relation to GOOGLE™ applications, the configuration component (38) may request a user's GOOGLE password which allows the interrupt utility (24) thereafter to change presence settings automatically, which thereby will interrupt for example notifications from GoogleTalk (whether loaded on the desktop or accessed from the cloud), Google+, Gmail and Google Hangout.

In another aspect, the configuration component (38) may also be linked to one or more access management components of one or more third party platforms, or in fact a general purpose access management utility that manages permissions and usernames and passwords across multiple computer systems or applications. This can further streamline the setup processes for the computer system (10).

In one implementation the integration component (40) consists of computer program component that provides a plug-in or equivalent that monitors an associated file system.

In another aspect of the implementation of the invention, the integration component (40) includes for internet messaging platforms a driver that is operable to connect to a networking service such as Skype™ for example and change the presence of the user to “Do Not Disturb”. The integration component (40) also may include a series of local APIs that enable integration with third party platforms such as for example Yahoo! Messenger™ or Skype™. The integration component (40) may also integrate with operating systems so as to block notifications by different applications. For example, for the WINDOWS™ operating system, the integration component (40) can suppress WINDOWS system message by operation of the WINDOWS API when the computer system (10) is in do-not-disturb mode.

In one example of the implementation of the present invention, the integration component (40), when executed, redirects selected online addresses to a local service, specifically by redirecting network communications by altering the ‘hosts’ file (letoc/hosts for Linux and OS-X and c:\\Windows\System32\Drivers\etc\hosts in windows). In one aspect, the user may need to allow the client to run as “Administrator” to alter the hosts file.

Various other integrations are possible to address differences between different platforms that affect the specific mechanisms to be used to implement the do-not-disturb functions of the present invention.

In another aspect of the invention, the client application (28) may present a screen that includes for example a timer that shows the time remaining of a pre-set “Do Not Disturb” interval. In one aspect, the client application (28) may also integrate with third party platforms to publish the user's current status.

In one aspect, the mobile device version of the client application (28) functions differently as the main disturbance for mobile devices, and specifically for smart phones the main disturbance, in the form of communication or notifications, may include incoming calls, SMS, and instant messages. This may also be the case for tablet computer if they are treated similarly to mobile devices on a given corporate network, in which case the main disturbances for a tablet could be the same as for a smart phone—depending on wireless services to the tablet computer. In any case, for smart phones and tablet computers in some cases, the main objective is to mute sounds associated with calls and notifications.

Muting the sound of notifications therefore eliminates the main source of disruption. In one aspect of the invention, the client application (28) automatically mutes the mobile device on which it is loaded, upon initiation of the do-not-disturb (DND) status of the present invention. Furthermore, the vibrate function can be also deactivated. However, mobile device operations otherwise can continue without disturbing the user.

In one implementation, the client application (28) on the mobile device integrates with the operating system of the mobile device by applying a system mute when the computer system's status is changed to do-not-disturb. In another possible implementation, the system's status is changed to do-not-disturb when a user is in an active call. Other features focused on allowing user's to manage their time more effective are possible.

A skilled reader will understand that the client application (28) can be modified to include various features for automating switching the computer system (10) to a do-not-disturb status, which triggers a communication to the server computer (22) which then switches all other devices (12) or platforms (14) to DND status automatically, based on a profile associated with the user or group of users established on the server computer (22). The integration component (40) can extract data for example from a calendar application, and the client application (28) can utilize location based functions of the mobile device, so as to for example detect a meeting involving user that may be associated with one or more attributes that require the user to switch to DND status, and the DND status across the various devices or platforms connected to the computer system, for the particular user, once the user enters the boardroom where the meeting will occur.

A client site may also include a group server (42), as shown in FIG. 1, that is configured to control the internal communications of a group of users, and also external communications to the cloud, including the server computer (22). The group server (42), for example, can optimize use of bandwidth and manage access to the client application (28) in order to maintain security of the solution.

### Diverting Calls to a VoIP Line to a Voice Mailbox

In one aspect of the present invention, the computer system (10) includes a mechanism for diverting calls from a VoIP line, as illustrated in FIG. 4.

In one possible implementation, the server computer (22) is configured to send an API command to a linked VoIP system (44) that changes the routing of a DID number to voicemail when the computer system (10) is set to DND. This makes the number unreachable automatically for the time period of the DND state, and effectively diverts calls to a VoIP line to a Voice Mailbox.

In one aspect, the computer system (10) utilizes DID or (Direct Inward Dialing) numbers that are used in VoIP systems and that can be obtained from a pool of numbers in any area code. The DID number can be used to “lead” the call into the system. The computer system (10) adapts the API command to the routing scheme implemented to by the VoIP system (44). Accordingly, the API command is configured to control the routing scheme of a specific DID or an extension of an IVR system to change a termination point.

### PBX System

In another aspect, the computer system (10) includes functionality that, with the required permissions send an API command to a PBX (46) that changes the routing mechanism to match the user's status on the computer system (10), i.e. whether the user's status is ON or OFF. The PBX (46) may be a public or a private PBX.

### Muting an Analog or IP Phone

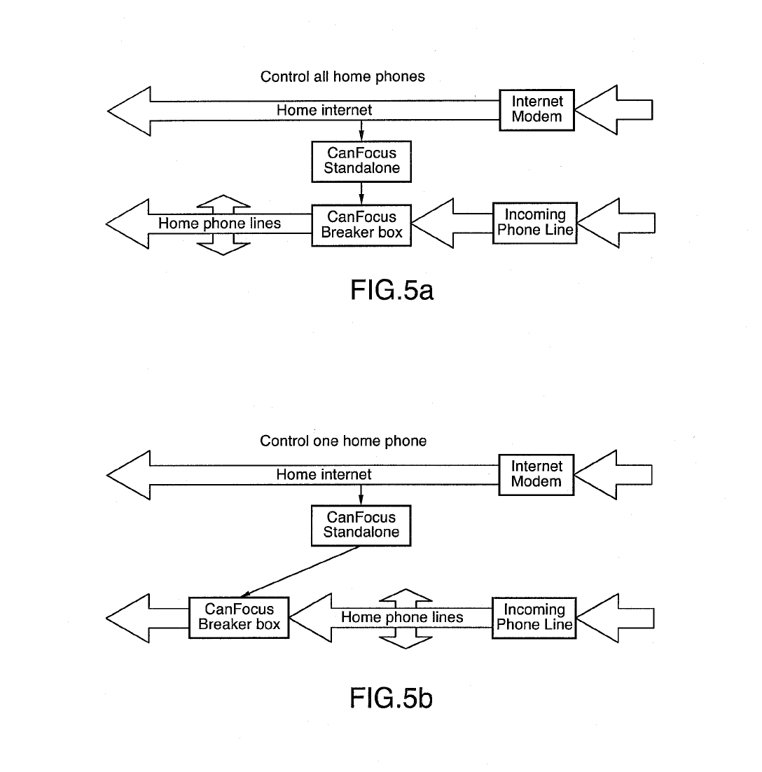

in one aspect of the invention, the computer system (10) may include at least one breaker device for interrupting an analog phone line. In one implementation, the breaker box includes: (A) a control input for receiving input from the clicker device (18), (B) a phone line input from an analog phone line, and (C) a phone line output back to the analog line. The breaker acts on a signal from computer system (10) to mute all analog phones connected to a circuit. Aspects of muting analog phones are shown in FIGS. 5a, 5b.

Essentially the same method may be used to mute an IP phone.

### Additional Details on Clicker Device 18

The clicker device (18), in one implementation, can include (A) an LED (which can be illuminated to indicate a certain state, e.g. a DND state); (B) a physical button enabling a user to physically turn the system ON or OFF; (C) a power source; and (D) a data connector to connect to the Internet, or to a computer device with an Internet connection.

In one aspect of the invention, the clicker device (18) may include system resources to support wireless communication between the clicker device unit of the clicker device (18) (in the case of a dual unit implementation) and the desktop computer. The wireless connection may also be between the clicker device (18) to the server computer (22). The wireless connection avoids the inconvenience of a physical connection. The wireless communication may be provided using a variety of different wireless protocols such as for example Wi-Fi, Zigbee, Bluetooth, RF, IR and others to provide the required-communication needs. Power however is a problem.

Certain possible configurations of the computer system including the clicker device (18) are shown in FIG. 6a, 6b.

### Pairing Process

When a clicker or communication device 18 is directly connected to a computing device with standard input and output means (e.g. PC, laptop, tablet, smartphone) or when a client application 28 is running on such a computing device, a username/password can be set up to associate the device to a specific user. For example, as soon as the user logs into a computing device, the computing device can notify the clicker device 18 right away that a user with a unique user ID (identified and verified by the username/password) has logged on, and the clicker device 18 can be paired up with the user automatically.

However, when the clicker is implemented as a standalone communication device connected to the network but not directly wired to a computing device that a user typically logs into, then a special pairing process is required for the user to initiate or resume using the standalone clicker device 18. This process is most needed for hoteling spaces where desks are not used by specific users but rather mobile workers come and go and use different desks all the time.

Prior to the step of receiving input from a user or a computer system associated to the user, the computer system 10 may require the pairing of the communication or clicker device to the user or the computer system associated to the user, especially if the communication device is a standalone clicker device. First, the clicker device can send a unique hardware identifier (e.g. MAC address) associated with the standalone clicker device to a pairing server as soon as it has booted up or powered on.

Based on the unique hardware identifier, the pairing server can immediately send back a user ID that was last assigned to the standalone clicker device before it was turned off or went offline. Once the clicker device has received the user ID, it can be paired with the user based on the user ID. This way the service of the clicker device can be resumed as per usual.

If the user currently ready to use the standalone clicker device is not associated with the user ID, then the user may initiate a new pairing session with the clicker device in accordance with the method below.

If a user wants to pair to a standalone clicker device for the first time or re-pair with the clicker device, the user can login into a website or a web portal from any Internet enabled device and request to pair. The user request for pairing may include at least the user ID, and may also include time of request, location of user, and so on. At this point, the user can turn on the clicker device, and as soon as it is turned on, it can send the unique hardware ID to the pairing server, indicating that it is available for pairing. The pairing server can then prompt the user to click and hold the clicker device (via a physical button) until further notice. Once the user has clicked and has been holding the dicker device for a brief period of time (e.g. 1 or 2 seconds), the clicker device and further send a signal or message to the pairing server indicating that it has been clicked and held. After a short while the pairing server can indicate to the user to release the clicker device. Once the user has released the clicker device, it can further send the pairing server a signal or message indicating that it has just been released. The pairing server can then determine if the dick-press and release can be distinctly identified as correct pairing commands (i.e. no other pairing processes are in progress at the same time), if so, the pairing server can assign or associate the clicker device's unique hardware ID (which was just released) to the user ID of the user within a proper timing.

In the event that there are more than one pairing requests in progress, the pairing server can keep all users pressing their clickers and asking the users to only release one by one. For example, the pairing server can ask first only user A to release clicker device X, while users B and C are still pressing down on clicker devices Y and Z, respectively. As soon as the user A has released the clicker device and the pairing server notified of such release, dicker device X can be identified based on its unique hardware ID, and the server can pair clicker device X with user A. The pairing server can then ask the next user to release and so on until it clears the pairing-in-process list.

After a pairing process of timed press and release is done between a user and a (standalone) clicker device, the system can ask the user to click and release the clicker device once (or twice) on command again to confirm the successful pairing.

A user can choose to unpair from a standalone clicker device by logging into a website and choosing to unpair. The pairing server, upon receiving the user ID in the user request, can proceed to send a command to the clicker device in order to disconnect the device from the user ID.

### User Conditioning

It is very helpful for adoption that the clicker device on users' desk is not green when they come to work in the morning. It could be red (e.g. DND state), or a third color (e.g. blue or white, a neutral state), but not green. The user is then obliged to click the clicker once to “start the day”. The overall computer system 10 can be designed to encourage this user behavour in order to encourage adoption of the clicker device throughout workplace.

This is because that when the light is not green first thing in the morning, it should be interpreted as to indicate that the user is “not in yet.” This way users and employees are constantly reminded or prodded regarding the presence of the clicker device on their desk, which can improve the adoption of the system.

### Analytics

Also as shown in FIG. 1, the server computer (22) also includes an analytics utility (48) that applies a plurality of analytical functions to data collected by a logger (50) to a database (50). The analytics utility (48) includes various features and functions for analyzing user behaviour to generate useful insights, including the improve the operations of the computer system (10). For example, the analytics utility (48) can generate insights in a number of areas such as for example users' decision-making process in selecting their do-not-disturb periods. The analytics utility (48) can generate for example insights on best practices for improving productivity. The computer system (10) may include for example an administration server (not shown) that logs events based on interactions of users or groups of users with the computer system (10) and based on such events generates information that may be used to streamline or automate processes, based on results from the analytics utility (48). For example the analytics utility (48) may establish that business related calls are the norm in an organization until 10 pm and therefore may allow communications up till that time, but then default to a personal context after that. Various other alternatives are possible.

In an implementation of the present invention, the system may be implemented through Session Initiated Protocol (“SIP”). SIP may provide for the following: (i) a flexible framework for handshaking between the network infrastructure and the handset; (ii) the establishment of user location (i.e. translating from a user's name to the user's current network address); (iii) feature negotiation so that all of the participants in a session can agree on the features to be supported among them; (iv) call management, for example adding, dropping, or transferring participants from the active call; (v) changing features of a session while the session is in progress.

Depending on the particular implementation and various associated factors such as the resources of the communications device, wireless network parameters, and other factors, different implementation architectures may be used for the present invention.

The functionality described herein may also be accessed as an Internet service, for example by accessing the functions or features described from any manner of computer device, by the computer device accessing a server computer, a server farm or cloud service configured to implement said functions or features.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. A processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including an EGM, A Web TV, a Personal Digital Assistant (PDA), a smart phone, a tablet or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, a computer may receive input information through speech recognition or in other audible formats.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The system and method may be embodied as a tangible, non-transitory computer readable storage medium (or multiple computer readable storage media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage media) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods as described herein need not reside on a single computer or processor, but may be distributed in a modular fashion amongst a number of different computers or processors to implement various aspects.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Depending on the particular implementation and various associated factors such as the resources of the communications device, wireless network parameters, and other factors, different implementation architectures may be used for the present invention.

It should also be understood that the computer server may be referred to as a server throughout this disclosure, and may be implemented as one or more servers in any possible server architecture or configuration including for example in a distributed server architecture, a server farm, or a cloud based computing environment.

Wherever the system is described as receiving input from the user of the communications device, it is to be understood that the input may be received through activation of a physical key on the communications device, through interaction with a touch screen display of the communications device, through a voice command received at the communications device and processed by the system, through a user gesture observed and processed at the communications device, through physically moving the communications device in a predetermined gesture pattern including shaking the communications device, through receiving data from another local or remote communications device associated with the user, or through any other sensory interaction with the communications device or otherwise controlling the communications device.

Similarly, wherever the system is described as providing an indication to the user or to the incoming caller, the indication may include playing a sound, playing a message, shaking the communications device, temporarily muting output of the communications device, displaying a message, icon, or other visual cue on a display of the communications device, or any other sensory interaction with the communications device.

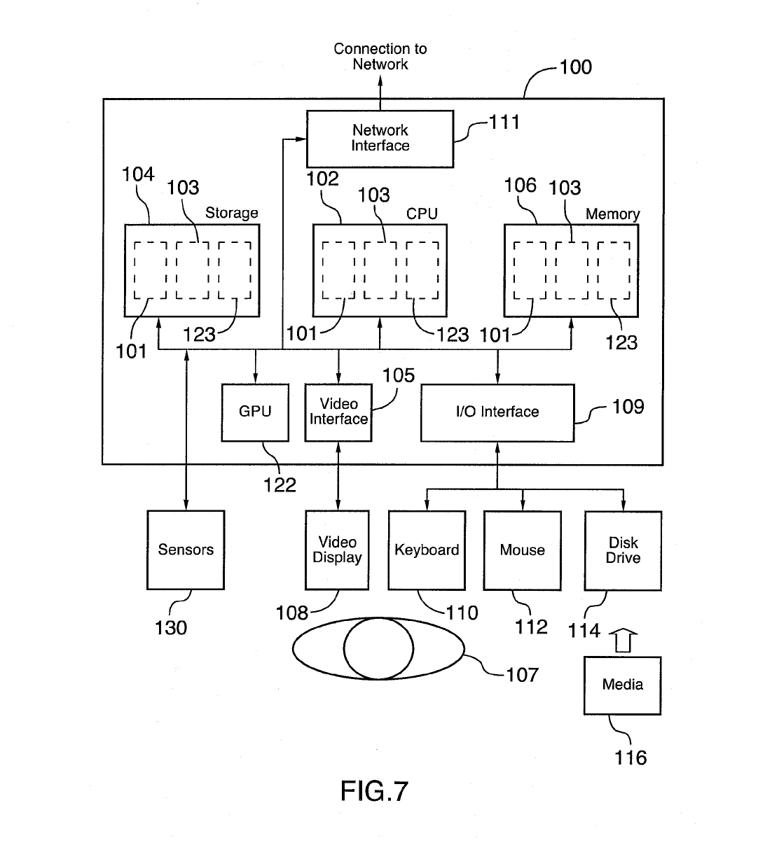

The present system and method may be practiced in various embodiments. A suitably configured computer device, and associated communications networks, devices, software and firmware may provide a platform for enabling one or more embodiments as described above. By way of example, FIG. 7 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The mobile application of the present invention may be implemented as a web service, where the mobile device includes a link for accessing the web service, rather than a native application.

The functionality described may also be implemented to any mobile platform, including the iOS platform, ANDROID™, WINDOWS™ or BLACKBERRY™.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. A computer-implemented method for time management, the method being performed by a communication device and a server connected to a communication network, the method comprising:
(a) Receiving an input from a user or a computer system associated with the user, the input comprising a request to interrupt or resume communications or notifications processed by one or more communication devices or communication platforms connected to the server;
(b) sending commands, by a processor of the server, to the one or more communication devices or communication platforms based on the request to interrupt or resume; and
(c) starting or terminating in real time or near real time, based on the request to interrupt or resume communications or notifications, respectively, a Do-Not-Disturb (DND) state, wherein the DND state comprises that all communications or notifications from the one or more communication devices or communication platforms be silenced or paused.

2. The computer-implemented method of claim 1, further comprising receiving an input from the user or the computer system associated to the user to indicate a neutral state, wherein the neutral state comprises that some communications or notifications from the one or more communication devices or communication platforms be silenced or paused.

3. The computer-implemented method of claim 1, further comprising receiving an input from the user or the computer system associated to the user to indicate a free-to-collaborate (FTC) state, wherein the FTC state comprises that none of communications or notifications from the one or more communication devices or communication platforms be silenced or paused.

4. The computer-implemented method of claim 1, further comprising, prior to the step of receiving input from a user or a computer system associated to the user, the step of pairing the communication device to the user or the computer system associated to the user, wherein the communication device is a standalone clicker device.

5. The computer-implemented method of claim 4, wherein pairing the communication device to the user or the computer system associated to the user comprises the steps of:
(a) sending, by the communication device, an unique hardware identifier associated with the communication device to a pairing server;
(b) based on the unique hardware identifier, sending, by the pairing server, a user ID that was last assigned to the communication device before it was turned off or went offline.

6. The computer-implemented method of claim 4, wherein pairing the communication device to the user or the computer system associated to the user comprises the steps of:
(a) sending, by the communication device, an unique hardware identifier associated with the communication device to a pairing server;
(b) receiving a pairing request by the pairing server, the pairing request comprising at least a user ID associated with the user;
(c) prompting the user to click and hold the communication device;
(d) receiving signals indicating that the user has clicked and is holding the communication device;
(e) prompting the user to release the communication device;
(f) receiving signals indicating the user has released the communication device; and
(g) pairing the communication device with the user by assigning an unique hardware identifier associated with the communication device to the user ID.

7. The computer-implemented method of claim 1, further comprising:
(a) determining a context;
(b) determining a set of rules based on the context, wherein the set of rules indicate one or more states associated with the user and with the communication device;
(c) starting, in real time or near real time, the one or more states based on the determined context, wherein the one or more states require none, some or all communications or notifications from the one or more communication devices or communication platforms be silenced or paused.

8. The computer-implemented method of claim 7, wherein the context is determined based on at least one of: day of week, time of day, location of the user, calendar information, default setting, user-defined setting, and group setting.

9. The computer-implemented method of claim 7, wherein if the determined context is a personal context, then the determined set of rules indicate a work-DND state, which comprises that all work related communications or notifications from the one or more communication devices or communication platforms be silenced or paused.

10. The computer-implemented method of claim 7, wherein if the determined context is a work context, then the determined set of rules indicate a personal-DND state, which comprises that all non-work related communications or notifications from the one or more communication devices or communication platforms be silenced or paused.

11. A communication device for time management, the device comprising a first unit comprising a visual indicator configured to display a current user state associated with a user, the first unit connected to a server over a communication network, wherein:
the first unit is configured to: (a) receive an input from the user, the input comprising a request to interrupt or resume communications or notifications processed by one or more communication devices or communication platforms connected to the server; and (b) send the request to the server; and
the server comprises a processor and a non-transitory computer-readable memory, the processor upon executing instructions stored in the non-transitory computer-readable memory is configured to:
upon receiving the request to interrupt or resume, send commands to the one or more communication devices or communication platforms based on the request to interrupt or resume; and
start or terminate in real time or near real time, based on the request to interrupt or resume communications or notifications, respectively, a Do-Not-Disturb (DND) state, wherein the DND state comprises that all communications or notifications from the one or more communication devices or communication platforms be silenced or paused.

12. The communication device of claim 11, further comprising a second unit mountable on a wall, the second unit comprising a visual indicator that is configured to be synchronized with the visual indicator of the first unit so that both the first and the second units can display the current user state associated with the user in real time or near real time.

13. The communication device of claim 12, wherein the first unit and the second unit are wirelessly connected.

14. The communication device of claim 13, further comprises a base unit that is configured to receive and charge the first unit or second unit, wherein the base unit is further configured to connect the first unit or second unit to the computer network.

15. The communication device of claim 14, wherein the first unit and the second unit are interchangeable.

16. The communication device of claim 11, wherein the processor of the server is configured to: receive a request from the first unit, the request indicating a neutral state, wherein the neutral state comprises that some communications or notifications from the one or more communication devices or communication platforms be silenced or paused.

17. The communication device of claim 11, wherein the processor of the server is configured to: receive a request from the first unit, the request indicating a free-to-collaborate (FTC) state, wherein the FTC state comprises that none of communications or notifications from the one or more communication devices or communication platforms be silenced or paused.

18. The communication device of claim 11, wherein the processor of the server is configured to:
(a) determine a context;
(b) determine a set of rules based on the context, wherein the set of rules indicate one or more states associated with the user and with the communication device;
(c) start, in real time or near real time, the one or more states based on the determined context, wherein the one or more states comprise none, some or all communications or notifications from the one or more communication devices or communication platforms be silenced or paused.

19. The communication device of claim 18, wherein the context is determined based on at least one of: day of week, time of day, location of the user, calendar information, default setting, user-defined setting, and group setting.

20. The communication device of claim 18, wherein if the determined context is a personal context, then the determined set of rules indicate a work-DND state, which comprises that all work related communications or notifications from the one or more communication devices or communication platforms be silenced or paused.

21. The communication device of claim 18, wherein if the determined context is a work context, then the determined set of rules indicate a personal-DND state, which comprises that all non-work related communications or notifications from the one or more communication devices or communication platforms be silenced or paused.
